(19) United States
(12) Patent Application Publication
(10) Pub. No.: US 2014/0082148 A1
(43) Pub. Date: Mar. 20, 2014

(54) SERVER, SYSTEM, AND METHOD FOR TRANSFERRING REQUEST

(71) Applicant: Ryuuichiroh NAKAYAMA, Kanagawa (JP)

(72) Inventor: Ryuuichiroh NAKAYAMA, Kanagawa (JP)

(73) Assignee: RICOH COMPANY, LTD., Tokyo (JP)

(21) Appl. No.: 14/022,393

(22) Filed: Sep. 10, 2013

(30) Foreign Application Priority Data
Sep. 18, 2012 (JP) 2012-204249

(51) Int. Cl. H04L 29/08

(52) U.S. Cl. CPC H04L 67/32
USPC 709/219

(57) ABSTRACT

A server includes a receiving unit that receives a request destined for a device and stores the request in a storage; and a responding unit that receives, from the device, report information for reporting a status change of the device, and sends the request stored in the storage to the device as a response to the report information.

### CROSS-REFERENCE TO RELATED APPLICATION

The present application is based upon and claims the benefit of priority of Japanese Patent Application No. 2012-204249, filed on Sep. 18, 2012, the entire contents of which are incorporated herein by reference.

### BACKGROUND OF THE INVENTION

1. Field of the Invention

An aspect of this disclosure relates to a server, a system, and a method for transferring a request.

2. Description of the Related Art

There exist devices to which functions can be added by installing application programs.

Meanwhile, cloud services have been getting attention in recent years. Here, it is possible to provide added value to users of devices by providing services for the devices via a network in a form of, for example, cloud services, Web services, or application service provider (ASP) services.

An application program installed in a device can control the device at desired timing via, for example, an application program interface (API) provided in the device. On the other hand, an application program for providing a service via a network (e.g., a cloud service) is provided in an external network environment that is outside of a network environment (e.g., an intranet of a company) where a device is installed. Accordingly, to control the device, the application program needs to send a request via a network to the device.

Here, however, because a firewall is generally provided between an intranet of a company and an external network environment, a request from the external network environment is blocked by the firewall (see, for example, Japanese Laid-Open Patent Publication No. 2002-342201).

### SUMMARY OF THE INVENTION

In an aspect of this disclosure, there is provided a server including a receiving unit that receives a request destined for a device and stores the request in a storage; and a responding unit that receives, from the device, report information for reporting a status change of the device, and sends the request stored in the storage to the device as a response to the report information.

### BRIEF DESCRIPTION OF THE DRAWINGS

FIG. 1 is a drawing illustrating an exemplary configuration of an information processing system according to an embodiment;

FIG. 2 is a block diagram illustrating an exemplary hardware configuration of a device according to an embodiment;

FIG. 3 is a block diagram illustrating an exemplary hardware configuration of an intermediation apparatus according to an embodiment;

FIG. 4 is a block diagram illustrating an exemplary functional configuration of an information processing system according to an embodiment;

FIG. 5 is a sequence chart illustrating an exemplary message transfer process according to a first embodiment;

FIG. 6 is a table illustrating an exemplary data structure of a message storage according to the first embodiment;

FIG. 7 is a sequence chart illustrating an exemplary message transfer process according to a second embodiment;

FIG. 8 is a table illustrating an exemplary data structure of a message storage according to the second embodiment;

FIG. 9 is a sequence chart illustrating an exemplary message transfer process according to a third embodiment;

FIG. 10 is a table illustrating an exemplary data structure of a message storage according to the third embodiment;

FIG. 11 is a sequence chart illustrating an exemplary message transfer process according to a fourth embodiment;

FIG. 12 is a table illustrating an exemplary data structure of a message storage according to the fourth embodiment; and

FIG. 13 is a drawing illustrating exemplary relationships among reporting units, transfer units, and service providing units.

### DESCRIPTION OF THE PREFERRED EMBODIMENTS

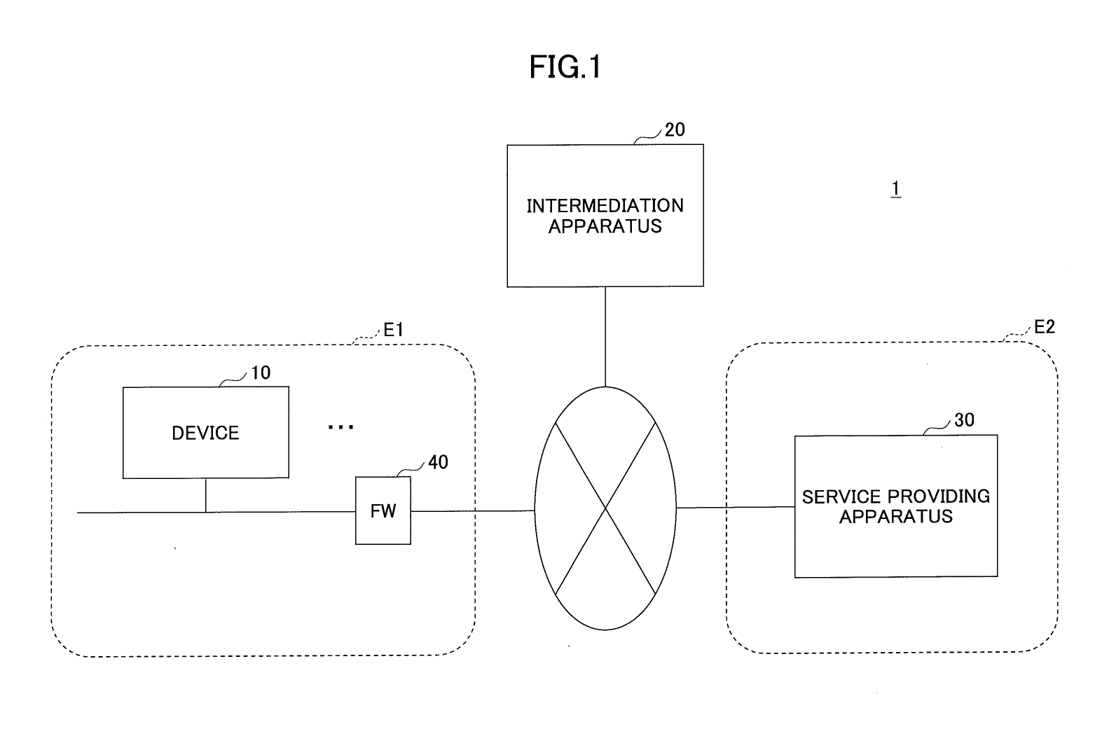

Preferred embodiments of the present invention are described below with reference to the accompanying drawings. FIG. 1 is a drawing illustrating an exemplary configuration of an information processing system 1 according to an embodiment. In the information processing system 1 of FIG. 1, an intermediation apparatus 20 is connected via a communication network such as a local area network (LAN), an intranet, or the Internet, to a user environment E1 and a service providing environment E2.

The intermediation apparatus 20 is a computer that intermediates between the user environment E1 and the service providing environment E2. Hereafter, a function or a service provided by the service intermediation apparatus 20 is referred to as an “intermediary service”. For example, the intermediation apparatus 20 provides the intermediary service as a cloud service on the Internet. Alternatively, the intermediation apparatus 20 may be provided as a private cloud in a company where the user environment E1 exists. Services provided via a network includes, for example, cloud services, Web services, and application service provider (ASP) services. In the present embodiment, for descriptive purposes, a cloud service is used as an example of a service provided via a network.

The service providing environment E2 is a system environment located in an organization that provides services via a network. The service providing environment E2 includes a service providing apparatus 30. The service providing apparatus 30 provides, via the network, services that are linked with a device 10 in the user environment E1. Similarly to the intermediation apparatus 20, the service providing apparatus 30 may instead be provided in the user environment E1. In other words, the service providing environment E2 may be included in the user environment E1.

The user environment E1 is a system environment in a company where the device 10 is used. The user environment E1 may include one or more devices 10.

In the present embodiment, it is assumed that the device 10 is a multifunction peripheral including two or more of functions such as printing, scanning, copying, and facsimile transmission and reception. Also, a device including one of the above functions may be used as the device 10. Further, any device including a communication function may be used as the device 10.

The user environment E1 includes a firewall (FW) 40 as an interface with an external network. The firewall 40 basically blocks requests from the outside of the user environment E1. Therefore, the service providing apparatus 30 cannot send a request directly to the device 10 to collaborate with the device 10. According to the present embodiment, the intermediation apparatus 20 transfers a request received from the service providing apparatus 30 to the device 10.

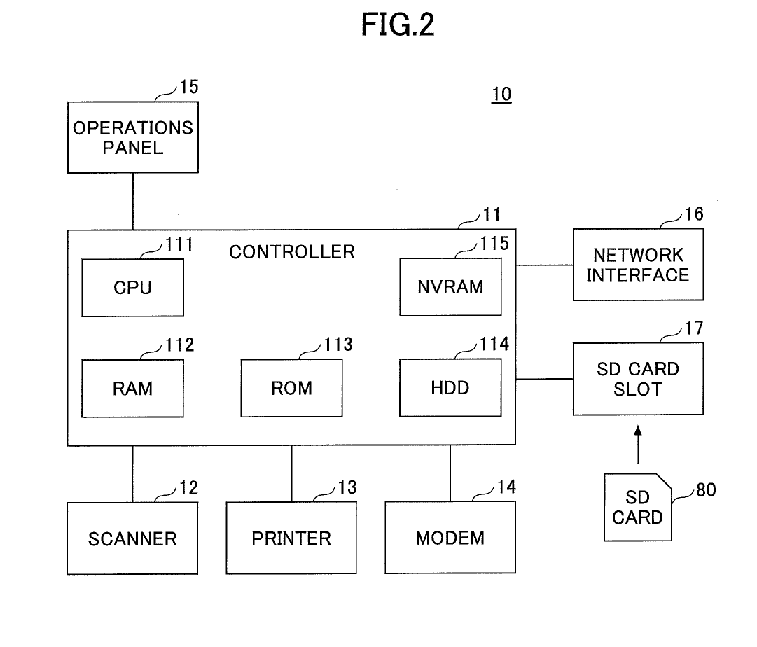

FIG. 2 is a block diagram illustrating an exemplary hardware configuration of the device 10. As illustrated by FIG. 2, the device 10 may include, as hardware components, a controller 11, a scanner 12, a printer 13, a modem 14, an operations panel 15, a network interface 16, and a secure digital (SD) card slot 17.

The controller 11 may include a central processing unit (CPU) 111, a random access memory (RAM) 112, a read-only memory (ROM) 113, a hard disk drive (HDD) 114, and a non-volatile RAM (NVRAM) 115. The ROM 113 stores, for example, programs and data used by the programs. The RAM 112 is used, for example, as a storage area into which programs are loaded and as a work area for the loaded programs. The CPU 111 executes the programs loaded into the RAM 112 to implement various functions. The HDD 114 stores, for example, programs and data used by the programs. The NVRAM 115 stores, for example, various settings.

The scanner 12 is a hardware component (image scanning unit) for scanning a document to obtain image data. The printer 13 is a hardware component (printing unit) for printing print data on a recording medium such as paper. The modem 14 is a hardware component for connecting the device 10 to a telephone line and is used to send and receive image data in facsimile communications. The operations panel 15 is a hardware component including an input unit such as buttons for receiving user inputs and a display unit such as a liquid crystal display panel. The network interface 16 is a hardware component for connecting the device 10 to a (wired or wireless) network such as a local area network (LAN). The SD card slot 17 reads, for example, programs stored in a secure digital (SD) card 80. With the device configured as described above, in addition to the programs stored in the ROM 113 and the HDD 114, programs stored in the SD card 80 can be loaded into the RAM 112 and executed. Instead of the SD card 80, any other storage medium (e.g., a CD-ROM or a universal serial bus (USB) memory) may be used for this purpose. That is, a storage medium that can be mounted on the device 10 is not limited to the SD card 80. When a storage medium other than the SD card 80 is used, the SD card slot 17 may be replaced with a hardware component corresponding to the storage medium used.

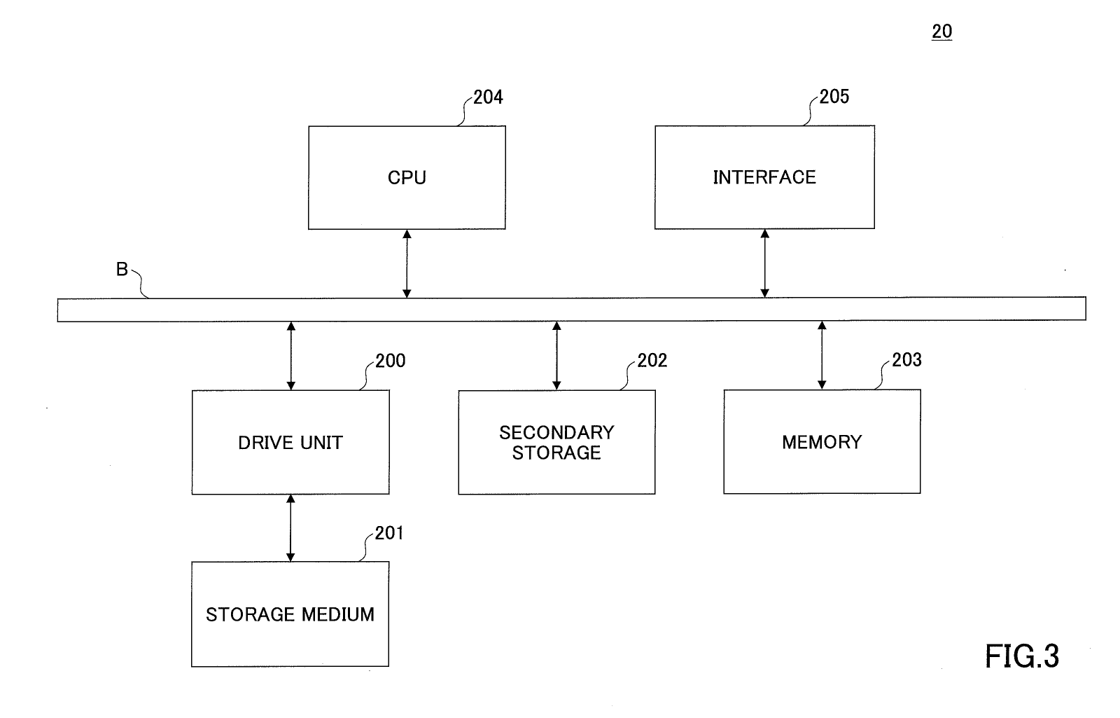

FIG. 3 is a block diagram illustrating an exemplary hardware configuration of the intermediation apparatus 20. As illustrated by FIG. 3, the intermediation apparatus 20 may include a drive unit 200, a secondary storage 202, a memory 203, a CPU 204, and an interface 205 that are connected to each other via a bus B.

Programs for implementing various processes performed at the intermediation apparatus 20 may be provided via a storage medium 201 such as a CD-ROM, a DVD-ROM, or a USB memory. When the storage medium 201 storing programs is mounted on the drive unit 200, the programs are read by the drive unit 200 from the storage medium 201 and are installed in the secondary storage 202. Programs may not necessarily be installed from the storage medium 201. For example, programs may be downloaded via a network from another computer. The secondary storage unit 202 stores the installed programs and other necessary files and data.

The memory 203 temporarily stores programs read from the secondary storage 202 when the programs are executed. The CPU 204 performs functions of the intermediation apparatus 20 according to the programs temporarily stored in the memory 203. The interface 205 connects the intermediation apparatus 20 to a network.

The service providing apparatus 30 may also have a hardware configuration as illustrated by FIG. 3. The intermediation apparatus 20 and the service providing apparatus 30 may be implemented by one computer. Also, each of the service intermediation apparatus 20 and the service providing apparatus 30 may be implemented by multiple computers.

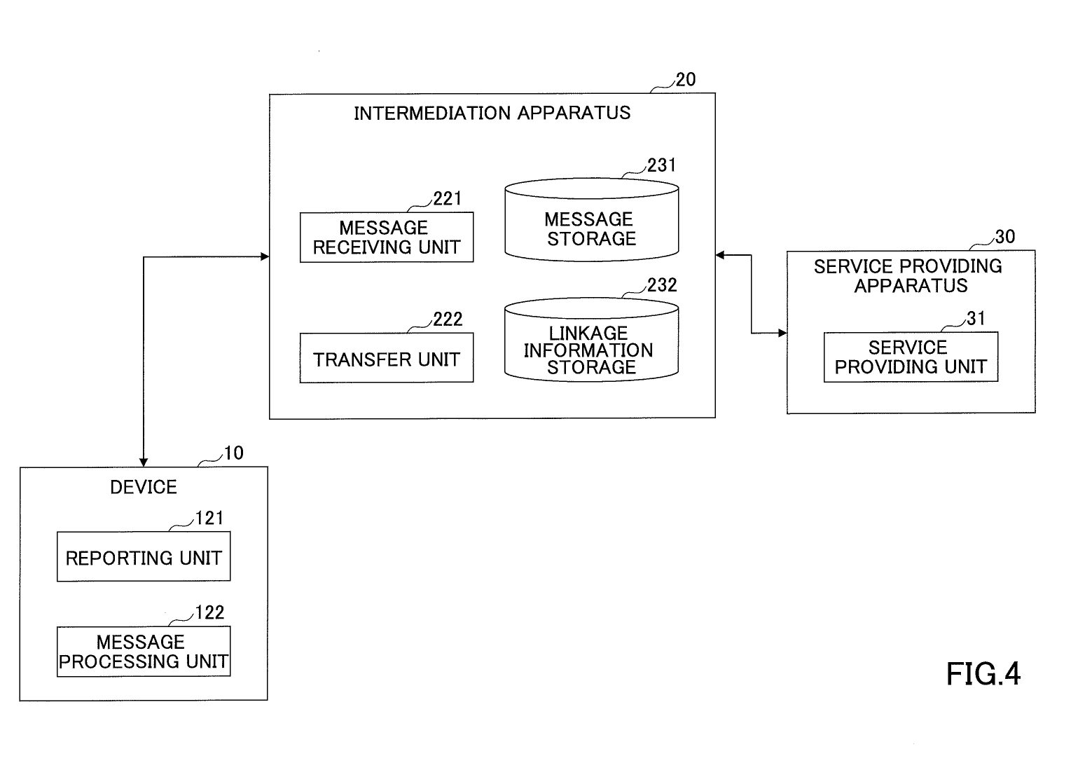

FIG. 4 is a drawing illustrating an exemplary functional configuration of the information processing system 1 according to the present embodiment. As illustrated by FIG. 4, the device 10 may include a reporting unit 121 and a message processing unit 122. These units may be implemented by executing one or more programs installed in the device 10 by the CPU 111.

The reporting unit 121 sends, to the intermediation apparatus 20, information indicating a status change of the device 10. Examples of the status change include the start and completion of a job, the occurrence of an error, a switch to an energy-saving mode, and a return from the energy-saving mode. Hereafter, the information reported from the device 10 to the intermediation apparatus 20 is referred to as an “event”. An event is sent to the intermediation apparatus 20 to allow the service providing apparatus 30 to detect a status change of the device 10. For example, this enables the service providing apparatus 30 to provide a service based on the status change of the device 10.

The message processing unit 122 performs a process according to a request sent from the service providing apparatus 30 to the device 10. In the present embodiment, a request sent from the service providing apparatus 30 to request the device 10 to perform a process is referred to as a “message”. Here, various types of messages may be sent from the service providing apparatus 30. Therefore, multiple message processing units 122 corresponding to the respective types of messages may be provided. In other words, one or more message processing units 122 implemented by different programs may be provided. In the descriptions below, however, the message processing unit 122 is expressed in the singular form for brevity.

Methods for sending a message from the service providing apparatus 30 to the device 10 are described later.

The intermediation apparatus 20 may include a message receiving unit 221 and a transfer unit 222. These functional units may be implemented by executing one or more programs installed in the intermediation apparatus 20 by the CPU 204. The intermediation apparatus 20 may also include a message storage 231 and a linkage information storage 232. These storages may be implemented, for example, by the secondary storage 202 and/or a storage device connected via a network to the intermediation apparatus 20.

The message receiving unit 221 receives messages from the service providing apparatus 30. That is, the service providing apparatus 30 sends messages for the device 10 to the message receiving unit 221 of the intermediation apparatus 20. When receiving a message, the message receiving unit 221 stores the message in the message storage 231 in association with accompanying information received together with the message. The accompanying information includes, for example, information indicating a destination of the message.

The transfer unit 222 receives an event from the device 10, and transfers the event to a preset destination. Also, when receiving an event from the device 10, the transfer unit 222 determines whether a message destined for the device 10 (i.e., a message associated with a destination that is the device 10) is stored in the message storage 231. When a message destined for the device 10 is stored in the message storage 231, the transfer unit 222 includes the message in a response to the event and sends the response to the device 10. Thus, a message sent from the service providing apparatus 30 and destined for the device 10 is transferred by the intermediation apparatus 20 to the device 10 as a response (or a part of a response) to an event sent from the device 10. This is because a response to an event sent from the device 10 can pass through the firewall 40 of the user environment E1.

The linkage information storage 232 stores correspondence information indicating the correspondence between events of the device 10 and services provided by the service providing apparatus 30. The correspondence information stored in the linkage information storage 232 is used by the transfer unit 222 to determine the destination of an event received from the device 10.

The service providing apparatus 30 includes a service providing unit 31. The service providing unit 31 may be implemented by executing one or more programs installed in the service providing apparatus 30 by a CPU of the service providing apparatus 30. Although one or more service providing units 31 may be provided, the serving providing unit 31 is expressed in the singular form for brevity. The service providing unit 31 provides a service(s) that is linked with the device 10. The service providing unit 31 may be implemented as Software as a Service (SaaS).

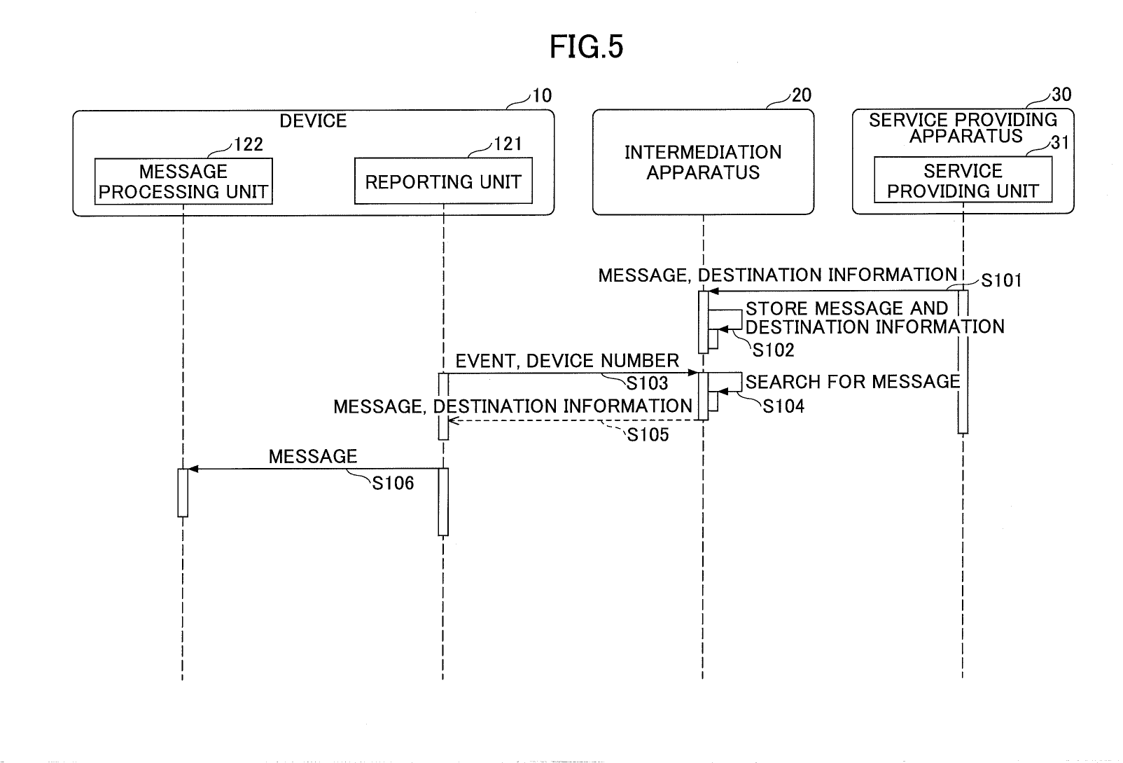

Below, exemplary processes performed in the information processing system 1 to send a message from the service providing apparatus 30 to the device 10 are described. FIG. 5 is a sequence chart illustrating an exemplary message transfer process according to a first embodiment.

To send a message to a certain device 10, the service providing unit 31 sends the message and destination information indicating the destination of the message to the message receiving unit 221 of the intermediation apparatus 20 (S101). For example, the service providing unit 31 may automatically send a message based on a predetermined setting or trigger. Also, the service providing unit 31 may send a message in response to a request (e.g., for controlling the device 10) entered using a communication terminal on a Web page for accessing the service providing unit 31. Here, it is assumed that no firewall, which blocks requests from the service providing unit 31, is provided between the intermediation apparatus 20 and the service providing apparatus 30.

The destination information may include identification information of the device 10 and identification information of a program of the device 10 to which the message is to be sent. Hereafter, the identification information of the device 10 is referred to as a “device number”. The device number may be any type of information, such as a production number, a serial number, a MAC address, or an IP address, that can identify the device 10. Also, the identification information of the program is hereafter referred to as a “program ID”.

When receiving the message and the destination information, the message receiving unit 221 of the intermediation apparatus 20 stores the message and the destination information in association with each other in the message storage 231 (S102).

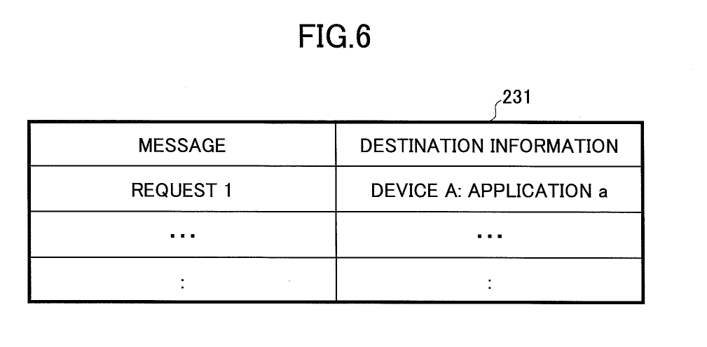

FIG. 6 is a table illustrating an exemplary data structure of the message storage 231 according to the first embodiment. As illustrated by FIG. 6, the message storage 231 stores a message (field) and destination information (field) in association with each other. In the example of FIG. 6, the destination information is expressed in a format “<device number>:<program ID>”. An exemplary record of the message storage 231 illustrated in FIG. 6 indicates that a message “Request 1” is to be sent to a program with a program ID “Application a” in a device 10 with a device number “Device A”.

Subsequent steps S103 through S106 may be performed asynchronously with or independently of step S102. When a status change occurs at the device 10, the reporting unit 121 of the device 10 sends an event indicating the status change and the device number of the device 10 to the transfer unit 222 of the intermediation apparatus 20 (S103). The event and the device number may be sent in a form of a request in a communication protocol. Also, types of events to be sent or reported to the transfer unit 222 may be limited. That is, instead of reporting all types of events indicating status changes, only events that are used by the service providing unit 31 linked with the device 10 may be reported. Types of events (or status changes) to be reported may be set in the device 10 when, for example, a configuration for linking the device 10 and the service providing unit 31 is performed.

When receiving the event and the device number (i.e., the request), the transfer unit 222 transfers the event to a destination defined in the linkage information storage 232. The destination may be the service providing unit 31 of the service providing apparatus 30, or any other apparatus or service.

Next, the transfer unit 222 searches the message storage 231 to find a message associated with the device number received together with the event (S104). More specifically, the transfer unit 222 searches the message storage 231 to find a message in a record whose destination information field includes the received device number.

When a message is found, the transfer unit 222 sends the message and the destination information associated with the message to the device 10 as a response to the request including the event and the device number (S105). The record including the sent message is removed by the transfer unit 222 from the message storage 231 to prevent duplicate transmission of the same message. When no message is found, the transfer unit 222 sends a response including no message and no destination information.

When receiving the response from the transfer unit 222, the reporting unit 121 of the device 10 sends the message included in the response to the message processing unit 122 implemented by a program corresponding to the program ID in the destination information included in the response (S106). The message processing unit 122 performs a process corresponding to the message sent from the reporting unit 121. When no message is included in the response, the reporting unit 121 does not send a message to the message processing unit 122.

For example, when the message is a “power-off request” and the program ID in the destination information indicates a power-off application, the message is sent to the message processing unit 122 implemented by the power-OFF application. When receiving the power-off request, the message processing unit 122 turns off the power of the device 10. In this case, the service providing unit 31 can provide a service that enables a user to turn off the power of the device 10 via a network such as the Internet. This is just an example of a service that can be implemented by the configuration or the method of the first embodiment.

Also in the first embodiment, similarly to a second embodiment described later, the message may be transferred to another device 10 that is different from the device 10 receiving the message as a response to the reported event.

As described above, according to the first embodiment, a message from the service providing unit 31 is included in a response to an event reported by the device 10 and is thereby sent to the device 10. This makes it possible to send or transfer a message from the service providing unit 31 through the firewall 40 to the device 10.

Also according to the first embodiment, a message is transferred to the device 10 when an event is reported by the device 10. This eliminates the need to regularly perform polling or to maintain a communication connection, and thereby makes it possible to reduce the communication load of the intermediation apparatus 20.

Further according to the first embodiment, an event is reported in an upward (or uplink) communication from the device 10 to the intermediation apparatus 20, and a message is sent in a downward (or downlink) communication from the intermediation apparatus 20 to the device 10. That is, an event and a message are transmitted within one “round-trip” communication between the device 10 and the intermediation apparatus 20. This makes it possible to increase the amount of information transmitted in one “round-trip” communication, and thereby makes it possible to improve the efficiency of communications between the device 10 and the intermediation apparatus 20.

Next, a second embodiment is described. Below, differences between the first and second embodiments are mainly described. Accordingly, configurations and methods of the second embodiment that are not described below may be substantially the same as those the first embodiment.

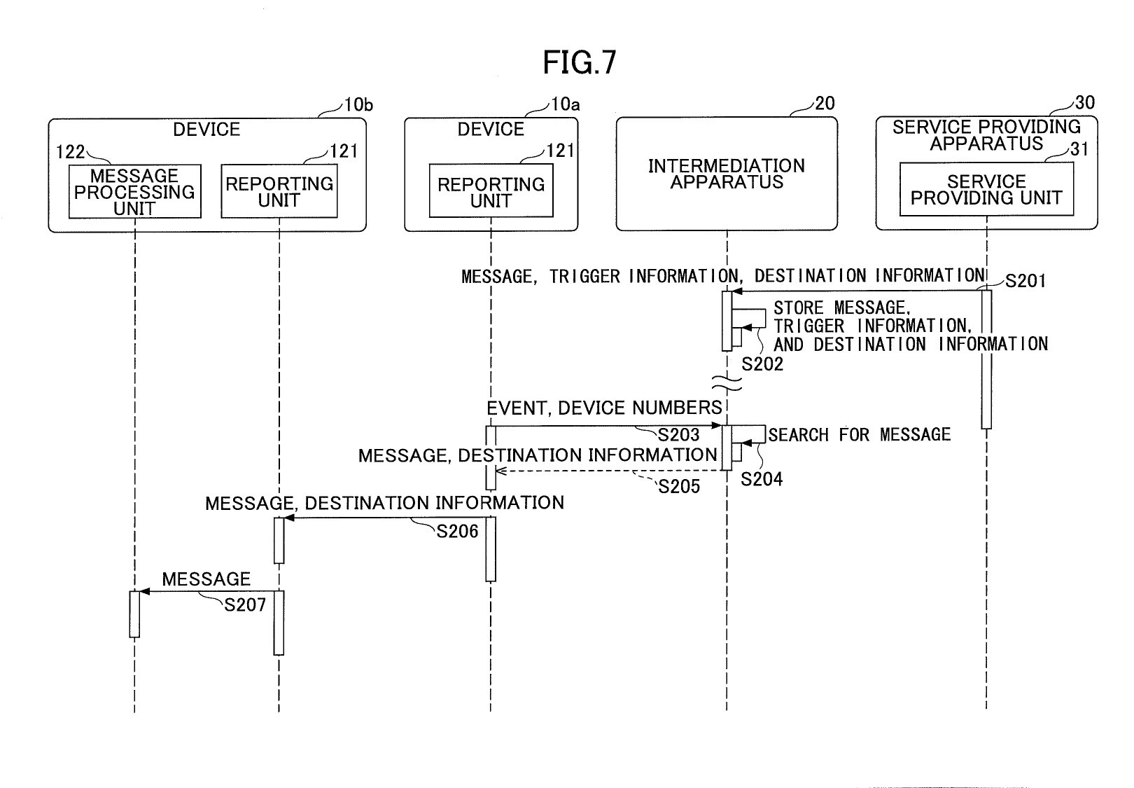

FIG. 7 is a sequence chart illustrating an exemplary message transfer process according to the second embodiment.

In the second embodiment, to send a message to a certain device 10, the service providing unit 31 sends trigger information in addition to the message and destination information of the message to the message receiving unit 221 of the intermediation apparatus 20 (S201). The trigger information indicates a trigger for sending or transferring the message to the device 10. More specifically, the trigger information specifies a type of event that triggers the transfer unit 222 to send a message to the device 10. For example, the service providing unit 31 sends, to the message receiving unit 221, a request indicating that “Send the message to the device 10 when this event is reported from the device 10”. Meanwhile, similarly to the first embodiment, the service providing unit 31 may send a message, for example, based on a predetermined setting or in response to a request.

When receiving the message, the trigger information, and the destination information, the message receiving unit 221 of the intermediation apparatus 20 stores the message, the trigger information, and the destination information in association with each other in the message storage 231 (S202).

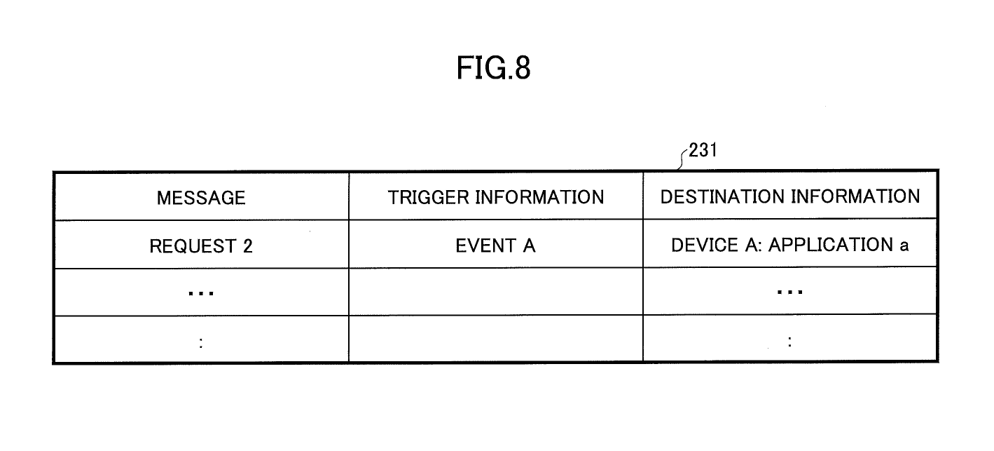

FIG. 8 is a table illustrating an exemplary data structure of the message storage 231 according to the second embodiment. As illustrated by FIG. 8, the message storage 231 stores a message (field), trigger information (field), and destination information (field) in association with each other.

Subsequent steps S203 through S207 may be performed asynchronously with or independently of step S202. When a status change occurs at a device 10a, the reporting unit 121 of the device 10a sends a request including an event indicating the status change and the device numbers of the device 10a and other devices 10 to the transfer unit 222 of the intermediation apparatus 20 (S203). That is, according to the second embodiment, when an event occurs at one device 10, the device numbers of multiple devices 10 (e.g., devices 10 that are in the same network segment as the device 10, or all devices 10 in the user environment E1) are sent to the transfer unit 222 together with the event. In the example of FIG. 7, the device numbers of the device 10a and a device 10b are sent to the transfer unit 222. The device 10a and the device 10b may be different types of devices.

When receiving the event and the device numbers, the transfer unit 222 transfers the event to a destination defined in the linkage information storage 232.

Next, the transfer unit 222 searches the message storage 231 to find a message associated with the received event or any one of the device numbers received together with the event (S204). More specifically, the transfer unit 222 searches the message storage 231 to find a message associated with trigger information indicating the received event or with one of the device numbers.

When a message is found, the transfer unit 222 sends the message and the destination information associated with the message to the device 10a as a response to the request including the event and the device numbers (S205). In the second embodiment, it is not necessary to remove the record including the sent message from the message storage 231. This is because the same message may be repeatedly sent in response to a particular event.

When receiving the response from the transfer unit 222, the reporting unit 121 of the device 10a transfers the message and the destination information in the response to the reporting unit 121 of the device 10b corresponding to the device number included in the destination information (S206).

Then, the reporting unit 121 of the device 10b sends the transferred message to the message processing unit 122 implemented by a program corresponding to the program ID included in the transferred destination information (S207). The message processing unit 122 performs a process corresponding to the message sent from the reporting unit 121.

The destination information may also include the device number of the device 10a. In this case, the device 10a also performs a process corresponding to the message. Also, similarly to the first embodiment, the destination information may include only the device number of the device 10a. In this case, the message may not be transferred to the device 10b.

Let us assume a case where trigger information indicates the completion of a scanning process at the device 10 and a message is a transfer request to transfer scanned image data (scanned image). It is also assumed that the message includes identification information (e.g., a uniform resource locator (URL)) of a destination of the scanned image. In this case, when an event indicating the completion of a scanning process is reported from the device 10, the transfer unit 222 sends, to the device 10, a transfer request to transfer a scanned image. In response, the message processing unit 122 of the device 10 transfers the scanned image to a destination specified in the transfer request. In this case, the service providing unit 31 can provide a transfer or uploading service for transferring or uploading a scanned image via a network such as the Internet. This is just an example of a service that can be implemented by the configuration or the method of the second embodiment.

A third embodiment is described below. Here, differences from the first and second embodiments are mainly described. Accordingly, configurations and methods of the third embodiment that are not described below may be substantially the same as those of the first or second embodiment.

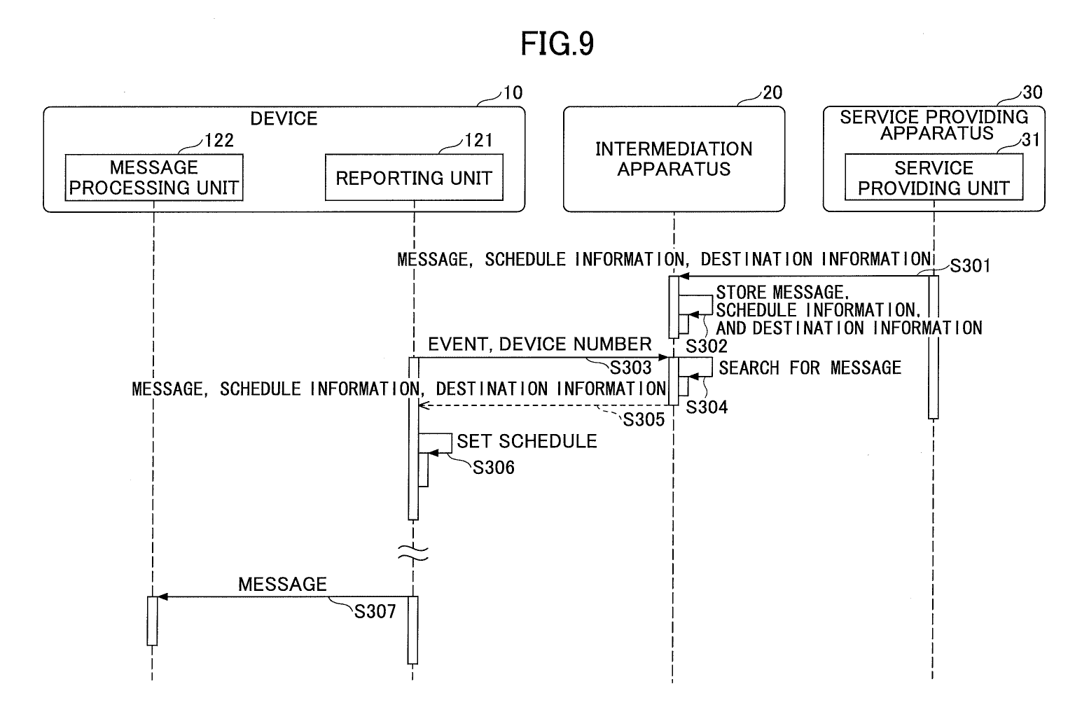

FIG. 9 is a sequence chart illustrating an exemplary message transfer process according to the third embodiment.

In the third embodiment, to send a message to a certain device 10, the service providing unit 31 sends schedule information in addition to the message and destination information of the message to the message receiving unit 221 of the intermediation apparatus 20 (S301). The schedule information indicates a time at which a process corresponding to the message is to be performed.

When receiving the message, the schedule information, and the destination information, the message receiving unit 221 of the intermediation apparatus 20 stores the message, the schedule information, and the destination information in association with each other in the message storage 231 (S302).

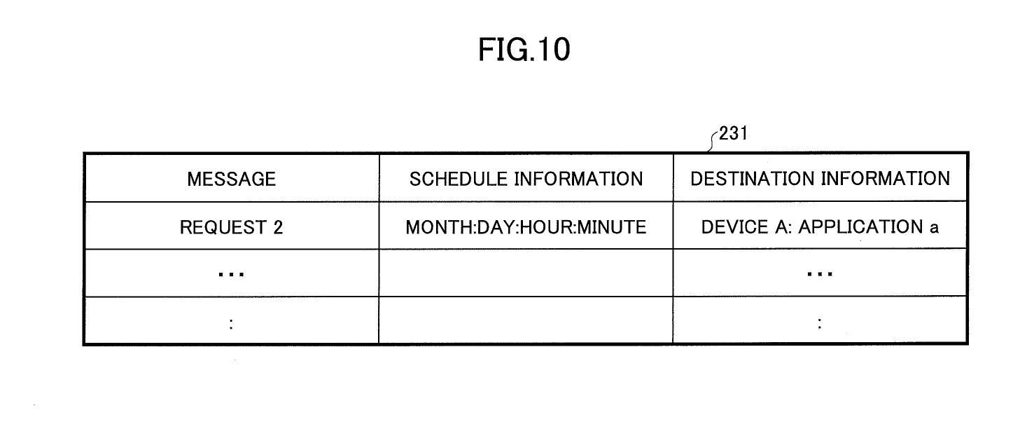

FIG. 10 is a table illustrating an exemplary data structure of the message storage 231 according to the third embodiment. As illustrated by FIG. 10, the message storage 231 stores a message (field), schedule information (field), and destination information (field) in association with each other.

Steps S303 through S305 of FIG. 9 are substantially the same as steps S103 through S105 of FIG. 5 except that at step S305, the schedule information associated with the message in the message storage 231 is also included in a response sent to the device 10.

When receiving the response from the transfer unit 222, the reporting unit 121 of the device 10 sets the time indicated by the schedule information as a reporting time at which the message included in the response is to be sent to a destination (S306). When the reporting time comes, the reporting unit 121 sends the message to the message processing unit 122 that is implemented by a program corresponding to the program ID included in the destination information in the response (S307). The message processing unit 122 performs a process corresponding to the message sent from the reporting unit 121.

For example, when the message is a request to update firmware of the device 10, the third embodiment makes it possible to cause the device 10 to update the firmware at a time specified by the schedule information.

The third embodiment may be combined with the second embodiment. For example, a combination of the second and third embodiments makes it possible to send a message together with schedule information to the device 10 when a specified event is reported from the device 10.

A fourth embodiment is described below. Here, differences from the first through third embodiments are mainly described. Accordingly, configurations and methods of the fourth embodiment that are not described below may be substantially the same as those of any one of the first through third embodiments.

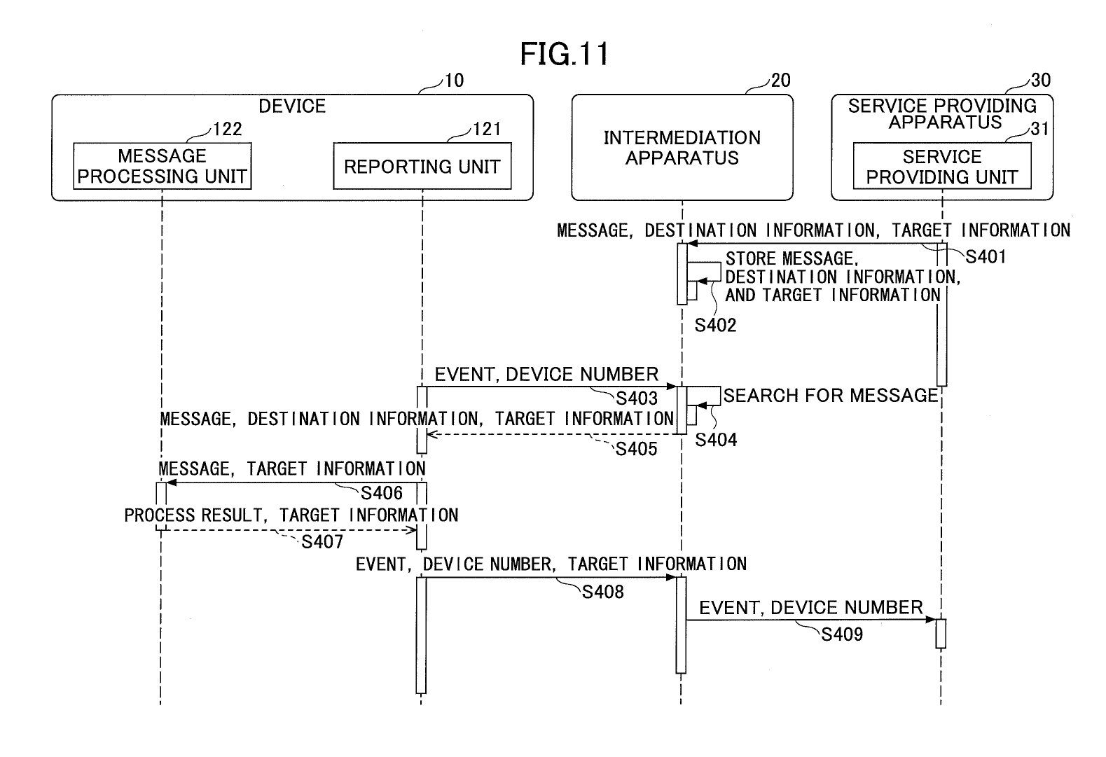

FIG. 11 is a sequence chart illustrating an exemplary message transfer process according to the fourth embodiment.

Steps S401 through S406 of FIG. 11 are substantially the same as steps S101 through S106 of FIG. 5 except that at step S401, target information is also sent to the message receiving unit 221 of the intermediation apparatus 20. The target information indicates a destination of a result of a process performed according to a message. The target information may be represented, for example, by a uniform resource locator (URL). Accordingly, at step S402, the target information is also stored in the message storage 231 in association with the message and the destination information.

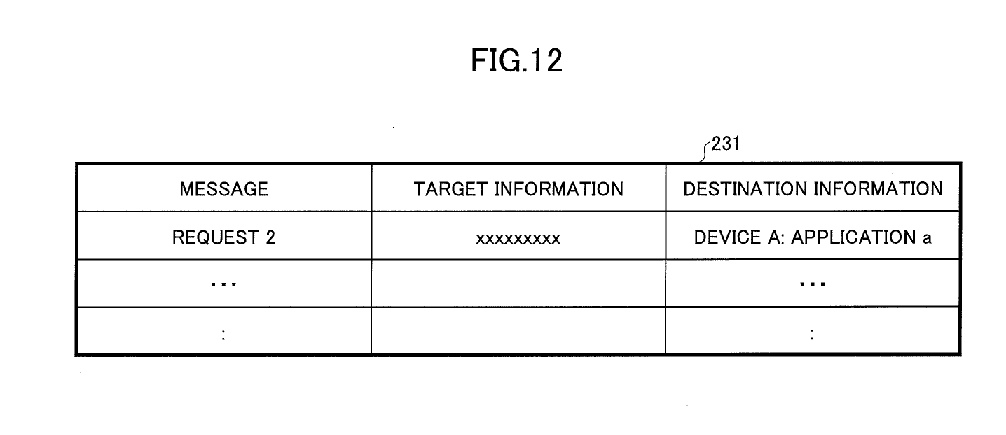

FIG. 12 is a table illustrating an exemplary data structure of the message storage 231 according to the fourth embodiment. As illustrated by FIG. 12, the message storage 231 stores a message (field), target information (field), and destination information (field) in association with each other.

At step S405, the transfer unit 222 sends the message, the target information, and the destination information to the device 10 as a response to an event reported from the device 10.

When receiving the response from the transfer unit 222, the reporting unit 121 of the device 10 sends the message and the target information in the response to the message processing unit 122 that is implemented by a program corresponding to the program ID included in the destination information in the response (S406). The message processing unit 122 performs a process corresponding to the message sent from the reporting unit 121.

When the process corresponding to the message is completed, the message processing unit 122 requests the reporting unit 121 to send a result of the process to a destination indicated by the target information (S407). Step S407 may not necessarily be performed in synchronization with (or immediately after) step S406.

Next, the reporting unit 121 sends an event indicating the result of the process, the device number, and the target information to the transfer unit 222 of the intermediation apparatus 20 (S408). Then, the transfer unit 222 transfers the event (the result of the process) and the device number to the destination indicated by the target information (S409). In the example of FIG. 11, it is assumed that the destination indicated by the target information is the service providing unit 31 that has sent the message. However, the destination indicated by the target information is not necessarily the service providing unit 31.

Also, when receiving the event at step S408, the transfer unit 222 may determine whether a message for the device 10 sending the event is stored in the message storage 231 and if a message is found, send the message to the device 10 as a response to the event.

For example, when the message is a request to transfer a scanned image, the message processing unit 122 of the device 10 sends the scanned image and target information via the reporting unit 121 to the transfer unit 222 of the intermediation apparatus 20. Then, the transfer unit 222 transfers the scanned image to a destination indicated by the target information.

The fourth embodiment may be combined with the second or third embodiment.

In the above embodiment, it is assumed that the service providing unit 31 specified destination information for each message. However, destination information may not necessarily be specified for each message. For example, the intermediation apparatus 20 may include predefined correspondence information indicating the corresponding between the service providing unit 31 and a device 10 to which a message is to be sent from the service providing unit 31. In this case, the transfer unit 222 determines a device 10 to which a message is to be sent based on the correspondence information. Also, there may be a message that is to be sent to a non-specific or unspecified device 10.

In the above embodiments, the transfer unit 222 and the service providing unit 31 may be implemented in the same computer.

In the above embodiments, the reporting unit 121 may be provided in an intranet in the user environment E1, and the transfer unit 222, the message receiving unit 221, and the service providing unit 31 may be provided on the Internet (e.g., on a Web, cloud, ASP, or so on). Also, all of the reporting unit 121, the transfer unit 222, the message receiving unit 221, and the service providing unit 31 may be provided on the Internet. Further, all of the reporting unit 121, the transfer unit 222, the message receiving unit 221, and the service providing unit 31 may be provided in an intranet.

Next, exemplary relationships among reporting units 121, transfer units 222, and service providing units 31 are described.

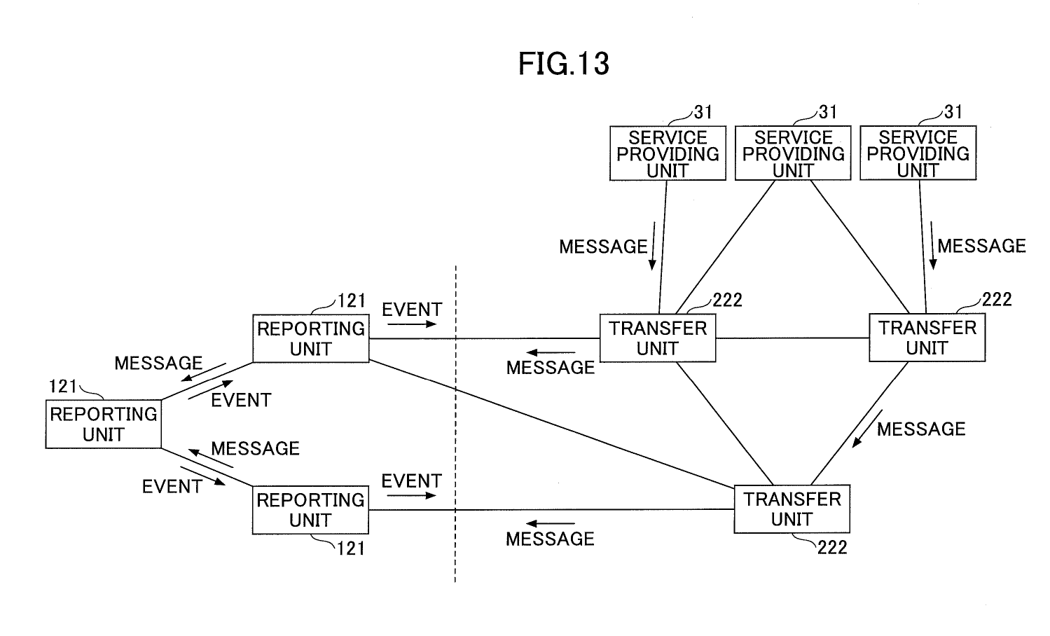

FIG. 13 is a drawing illustrating exemplary relationships among reporting units 121, transfer units 222, and service providing units 31. In FIG. 13, for brevity, it is assumed that the transfer unit 222 includes the message receiving unit 221.

As illustrated in FIG. 13, one transfer unit 222 may be used by multiple service providing units 31 and/or multiple reporting units 121. Meanwhile, multiple transfer units 222 may be available for one service providing unit 31 and/or one reporting unit 121. Also, multiple transfer units 222 may communicate or collaborate with each other. That is, messages and/or events may be transferred between multiple transfer units 222.

With the relationships as described above, the service providing unit 31 can select and use one of the transfer units 222 based on their status. For example, the service providing unit 31 may be configured to select a transfer unit 222 with a low processing load so that a message can be quickly transferred.

The reporting unit 121 may also be configured to select a transfer unit 222 with low processing load so that a message can be quickly transferred and received.

Also, as described in the second embodiment, the reporting units 121 may be configured to communicate with each other. This makes it possible to quickly transfer a message even to a device 10 with a low event-reporting frequency via the reporting unit 121 of another device 10.

In the above embodiments, it is assumed that the device 10 is an image forming device. However, the present invention may also be applied to any other type of device, such as a projector, a digital camera, a cell phone, or a smartphone, that includes a communication function.

In the above embodiments, the intermediation apparatus 20 is an example of a server, the message receiving unit 221 is an example of a receiving unit, the transfer unit 222 is an example of a responding unit, the reporting unit 121 is an example of a transmitting unit, and the message processing unit 122 is an example of a processing unit.

A server, a system, and a method for transferring a request via a network to a device are described above as preferred embodiments. However, the present invention is not limited to the specifically disclosed embodiments, and variations and modifications may be made without departing from the scope of the present invention.

What is claimed is:

1. A server, comprising:
a receiving unit that receives a request destined for a device and stores the request in a storage; and
a responding unit that receives, from the device, report information for reporting a status change of the device, and sends the request stored in the storage to the device as a response to the report information.

2. The server as claimed in claim 1,
wherein the receiving unit receives type information indicating one of multiple types of report information together with the request, and stores the type information in association with the request in the storage; and
wherein the responding unit sends, to the device, the request that is stored in the storage in association with the type information corresponding to the received report information, as the response to the report information.

3. The server as claimed in claim 1,
wherein the receiving unit receives, together with the request, time information indicating a time at which the device is to be caused to perform a process corresponding to the request, and stores the time information in association with the request in the storage; and
wherein the responding unit sends, to the device, the request and the time information stored in the storage in association with the request as the response to the report information.

4. The server as claimed in claim 1,
wherein the receiving unit receives, together with the request, target information indicating a destination to which a result of a process corresponding to the request is to be sent, and stores the target information in association with the request in the storage; and
wherein the responding unit sends, to the device, the request and the target information stored in the storage in association with the request as the response to the report information.

5. The server as claimed in claim 1,
wherein the receiving unit receives, together with the request, identification information of the device to which the request is to be sent, and stores the identification information in association with the request in the storage; and
wherein the responding unit sends, to the device, the request that is stored in the storage in association with the identification information of the device sending the report information, as the response to the report information.

6. A system, comprising:
a server; and
a device,
wherein the server includes
a receiving unit that receives a request destined for the device and stores the request in a storage, and
a responding unit that receives, from the device, report information for reporting a status change of the device, and sends the request stored in the storage to the device as a response to the report information; and
wherein the device includes
a transmitting unit that transmits the report information to the server, and
a processing unit that performs a process corresponding to the request included in the response sent from the server.

7. The system as claimed in claim 6,
wherein the receiving unit receives type information indicating one of multiple types of report information together with the request, and stores the type information in association with the request in the storage; and
wherein the responding unit sends, to the device, the request that is stored in the storage in association with the type information corresponding to the received report information, as the response to the report information.

8. The system as claimed in claim 6,
wherein the receiving unit receives, together with the request, time information indicating a time at which the device is to be caused to perform the process corresponding to the request, and stores the time information in association with the request in the storage; and
wherein the responding unit sends, to the device, the request and the time information stored in the storage in association with the request as the response to the report information.

9. The system as claimed in claim 6,
wherein the receiving unit receives, together with the request, target information indicating a destination to which a result of the process corresponding to the request is to be sent, and stores the target information in association with the request in the storage; and
wherein the responding unit sends, to the device, the request and the target information stored in the storage in association with the request as the response to the report information.

10. The system as claimed in claim 6,
wherein the receiving unit receives, together with the request, identification information of the device to which the request is to be sent, and stores the identification information in association with the request in the storage; and
wherein the responding unit sends, to the device, the request that is stored in the storage in association with the identification information of the device sending the report information, as the response to the report information.

11. A method, comprising:
steps, performed by a computer, of
receiving a request destined for a device and storing the request in a storage, and
receiving, from the device, report information for reporting a status change of the device, and sending the request stored in the storage to the device as a response to the report information; and
steps, performed by the device, of
transmitting the report information to the computer, and
performing a process corresponding to the request included in the response sent from the computer.

12. The method as claimed in claim 11,
wherein the computer receives type information indicating one of multiple types of report information together with the request, and stores the type information in association with the request in the storage; and
wherein the computer sends, to the device, the request that is stored in the storage in association with the type information corresponding to the received report information, as the response to the report information.

13. The method as claimed in claim 11,
wherein the computer receives, together with the request, time information indicating a time at which the device is to be caused to perform a process corresponding to the request, and stores the time information in association with the request in the storage; and
wherein the computer sends, to the device, the request and the time information stored in the storage in association with the request as the response to the report information.

14. The method as claimed in claim 11,
wherein the computer receives, together with the request, target information indicating a destination to which a result of a process corresponding to the request is to be sent, and stores the target information in association with the request in the storage; and
wherein the computer sends, to the device, the request and the target information stored in the storage in association with the request as the response to the report information.

15. The method as claimed in claim 11,
wherein the computer receives, together with the request, identification information of the device to which the request is to be sent, and stores the identification information in association with the request in the storage; and
wherein the computer sends, to the device, the request that is stored in the storage in association with the identification information of the device sending the report information, as the response to the report information.
